(19) United States
(12) Patent Application Publication
(10) Pub. No.: US 2006/0056281 A1
(43) Pub. Date: Mar. 16, 2006

(54) Method and system for time-domain transmission diversity in orthogonal frequency division multiplexing

(75) Inventors: Chiu Ngo, San Francisco, CA (US); Jun Shen, Palo Alto, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 10/938,254

(22) Filed: Sep. 10, 2004

(51) Int. Cl. H04J 11/00

(52) U.S. Cl. 370/208

(57) ABSTRACT

A method of provided for transmitting and receiving OFDM data signals via multiple outputs of a channel including multiple sub-channels. Transmit data streams are modulated by de-multiplexing the data streams into multiple parallel frequency-domain sub-channel data for conversion into time-domain data; and frequency-domain data for each sub-channel is converted into time-domain data. For each sub-channel, the corresponding time-domain data is differentially encoded to obtain differentially encoded time-domain data; and transmitting the differentially encoded time-domain data. The received signals are converted into digital data signals, and for each sub-channel, corresponding time-domain data from the data signals is differentially decoded to obtain differentially decoded time-domain data. The time-domain data for each sub-channel is converted into frequency-domain data and the frequency-domain data is demodulated into data streams by de-multiplexing the data streams into multiple parallel frequency-domain sub-channel data.

### FIELD OF THE INVENTION

The present invention relates generally to data communication, and more particularly, to data communication with transmission diversity using Orthogonal Frequency Division Multiplexing (OFDM) in multiple antenna channels.

### BACKGROUND OF THE INVENTION

In wireless communication systems, antenna diversity plays an important role in increasing the system link robustness. OFDM is used as a modulation technique for transmitting digital data using radio frequency signals (RF). In OFDM, a radio signal is divided into multiple sub-signals that are transmitted simultaneously at different frequencies to a receiver. Each sub-signal travels within its own unique frequency range (sub-channel), which is modulated by the data. OFDM distributes the data over multiple channels, spaced apart at different frequencies.

Conventionally, OFDM modulation has been performed in a using a transform such as Fast Fourier Transform (FFT) process wherein bits of data are encoded in the frequency-domain onto sub-channels. As such, in the transmitter, an Inverse FFT (IFFT) is performed on the set of frequency channels to generate a time-domain OFDM symbol for transmission over a communication channel. The IFFT process converts the frequency-domain phase and amplitude data for each sub-channel into a block of time-domain samples which are converted to an analogue modulating signal for an RF modulator. In the receiver, the OFDM signals are processed by performing an FFT process on each symbol to convert the frequency-domain data into time-domain data, and the data is then decoded by examining the phase and amplitude of the sub-channels. Therefore, at the receiver the reverse process of the transmitter is implemented, wherein the FFT process in the receiver extracts the phase and amplitude of each received sub-channel from the received samples.

Further, conventionally, transmit antenna diversity schemes are used to improve the OFDM system reliability. Such transmit diversity schemes in OFDM systems are encoded in the frequency-domain as described. However, this creates multiple independent replicas in the frequency-domain that can only be effective in the frequency-selective fading channels. Such methods are not effective for the impulsive interference channels such as generated in power switching of various devices in a home environment.

There is, therefore, a need for a method and system for time-domain transmission diversity in OFDM which is effective for impulsive interference channels.

### BRIEF SUMMARY OF THE INVENTION

The present invention addresses the above needs. In one embodiment, the present invention provides a method for transmitting OFDM data signals via multiple outputs of a channel including multiple sub-channels The method comprises the steps of modulating transmit data streams by de-multiplexing the data streams into multiple parallel frequency-domain sub-channel data for conversion into time-domain data; converting frequency-domain data for each sub-channel into time-domain data; for each sub-channel, differentially encoding the corresponding time-domain data to obtain differentially encoded time-domain data; and transmitting the differentially encoded time-domain data.

Transmitting the data includes the steps of converting the time domain data into analog data; modulating the analog data into a signal for RF transmission; and transmitting the signal. The step of differentially encoding the time-domain data further includes the steps of using a diversity encoder to encode the time-domain data into diversity encoded time-domain data. And, the steps of converting frequency-domain data into time-domain data further includes the steps of performing IFFT on the frequency-domain data to generate the time-domain data.

In another embodiment, the present invention provides a method for receiving OFDM data signals via multiple outputs of a channel including multiple sub-channels. The method comprises the steps of receiving the data signals; converting the analog data signals into digital data signals; for each sub-channel, differentially decoding corresponding time-domain data from the data signals to obtain differentially decoded time-domain data; converting the time-domain data for each sub-channel into frequency-domain data and demodulating the frequency-domain data into data streams by de-multiplexing the data streams into multiple parallel frequency-domain sub-channel data.

The step of differentially decoding the time-domain data further includes the steps of using a diversity decoder to decode the time-domain data into diversity decoded time-domain data. And, the steps of converting time-domain data into frequency-domain data further includes the steps of performing FFT on the time-domain data to generate the frequency-domain data.

In another embodiment the present invention provides a system for transmitting and receiving OFDM data signals via multiple outputs of a channel including multiple sub-channels. The system comprises a transmitter including a transmit transform processor that converts frequency-domain data for each sub-channel into time-domain data; and a transmit differential processor that differentially encodes each sub-channel time-domain data to obtain differentially encoded time-domain data. The system further comprises a receiver including a receive differential processor that for each sub-channel, differentially decodes corresponding time-domain data to obtain differentially decoded time-domain data; and a receive transform processor that converts the time-domain data for each sub-channel into frequency-domain data.

The transmitter further comprises a sub-channel modulator that modulates data streams by de-multiplexing the data streams into multiple parallel frequency-domain sub-channel data, wherein the sub-channel modulator provides the frequency-domain sub-channel data to the transform processor for conversion into time-domain data. The transmitter can further comprise a signal transmitter that transmits the differentially encoded time-domain data, wherein the signal transmitter includes a digital-to-analog converter that converts the time domain data into analog data; and a transmission modulator that modulates the analog data into a signal for RF transmission.

The transmit differential processor comprises a diversity encoder to encode the time-domain data into diversity encoded time-domain data. And, the transmit transform processor comprises an IFFT processor that converts the frequency-domain data to generate the time-domain data.

The receiver further comprises a receiver demodulator that demodulates RF received signals into analog data signals; and an analog-to-digital converter that converts the analog data signals into digital data signals for differential decoding by the differential processor. The receiver can further comprise a sub-channel demodulator that demodulates the frequency-domain data from the transform process into data streams by de-multiplexing the data streams into multiple parallel frequency-domain sub-channel data. The receive differential processor comprises a diversity decoder to decode the time-domain data into diversity decoded time-domain data. And, the receive transform processor comprises an FFT processor that converts the time-domain data to the frequency-domain data. Further, the transmitter and the receiver can utilize wireless communication therebetween, wherein the transmitter further includes multiple transmit antennas and the receiver further includes multiple receive antennas.

These and other features, aspects and advantages of the present invention will become understood with reference to the following description, appended claims and accompanying figures.

### BRIEF DESCRIPTION OF THE DRAWINGS

FIG. 1 shows a functional block diagram of a conventional OFDM transmit/receive system;

FIG. 2 shows an example functional block diagram of the architecture for time-domain transmit/receive diversity in an OFDM system according to an embodiment of the present invention;

FIG. 3 shows an example functional block diagram of the architecture for time-domain transmit/receive diversity in an OFDM system according to another embodiment of the present invention;

FIG. 4 shows an example functional block diagram of the architecture for frequency-domain and time-domain transmit/receive diversity in an OFDM system according to yet another embodiment of the present invention; and

FIG. 5 shows an example flow chart of the steps of for time-domain transmit/receive diversity in OFDM according to another embodiment of the present invention.

### DETAILED DESCRIPTION OF THE INVENTION

In one embodiment, the present invention provides a system and method for time-domain transmission diversity in OFDM which is at least effective for impulsive interference channels, e.g., such as generated in power switching of various devices in a home environment.

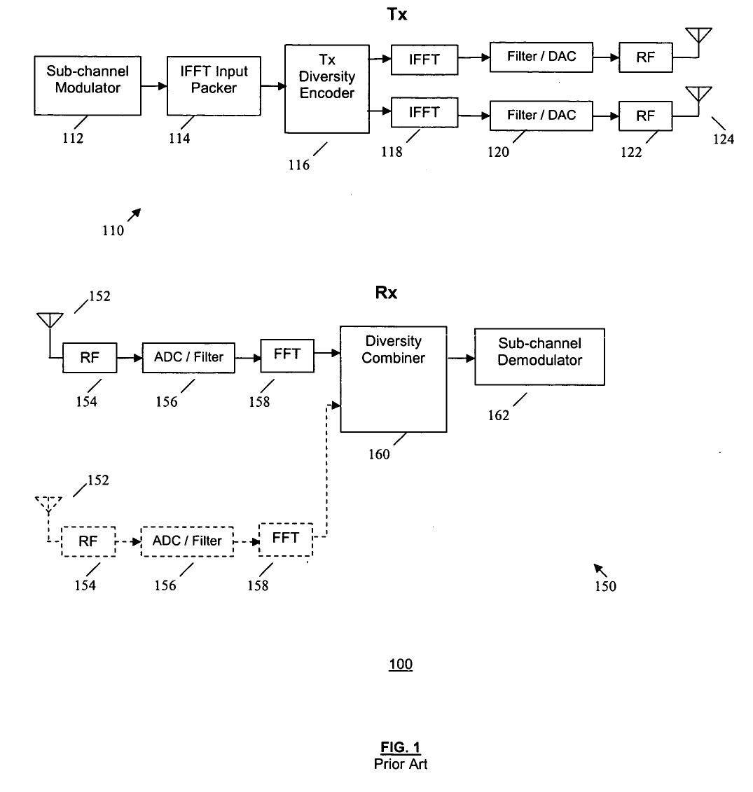

FIG. 1 shows a block diagram of a conventional OFDM system 100 including a transmitter (Tx) 110 and a receiver (Rx) 150. The transmitter 110 comprises a sub-channel modulator 112, an IFFT input packer 114, a diversity encoder 116, two IFFT blocks 118, two Filter/Digital-to-Analog-Converters (Filter/DAC) 120, two RF modulator blocks 122 and two antennas 124. The filter for “Filter/DAC” is for interpolation (oversampling) whereas the filter for “ADC/filter” is for decimation (unsampling).

In the transmitter 110 of FIG. 1, the IFFT blocks 118 convert frequency-domain data to time-domain data to generate a time-domain OFDM symbol for transmission over a communication channel (e.g., RF channel). Specifically, the IFFT blocks 118 convert the frequency-domain phase and amplitude data for each sub-channel into time-domain samples which are converted to analogue modulating signals by the Filter/DACs 120 for the RF modulators 122. The diversity encoder 116 provides transmit diversity in the frequency-domain (i.e., implements frequency-domain diversity), which is suitable for cases where different frequencies have different attenuations. However, no diversity is achieved for the impulsive interference channels.

The transmitter 110 uses transmit antenna diversity to improve the OFDM system reliability, wherein the transmit diversity scheme is encoded in the frequency-domain. However, this creates multiple independent replicas in the frequency-domain that can only be effective in the frequency-selective fading channels. Such methods are not effective for the impulsive interference channels such as generated in power switching of various devices in a home environment.

The receiver 150 comprises an antenna 152, an RF demodulator 154, an Analog-to-Digital-Converter/Filter (ADC/Filter) 156, an FFT block 158, a diversity combiner/decoder 160 and a sub-channel demodulator 162. As shown by dashed lines in FIG. 1, the receiver 150 may include one or more other antennas 152, wherein for each antenna 152, an additional RF demodulator 154, an additional ADC/Filter 156 and an additional FFT block 158 are needed to form a path before connection to the diversity combiner 160. In the receiver 150, the OFDM signals are converted from frequency-domain data to time-domain data by the FFT blocks 158, where FFT is performed on each symbol to convert the frequency-domain into time-domain. The time-domain data is then decoded by diversity combiner/decoder 160 that examines the phase and amplitude of the sub-channels. As such, in the receiver 150, the reverse process of the transmitter 110 is implemented, wherein the FFT process extracts the phase and amplitude of each received sub-channel from the received samples, and the diversity combiner 160 provides receive diversity in the frequency domain. As noted, such conventional methods are not effective for the impulsive interference channels such as generated in power switching of various devices in a home environment.

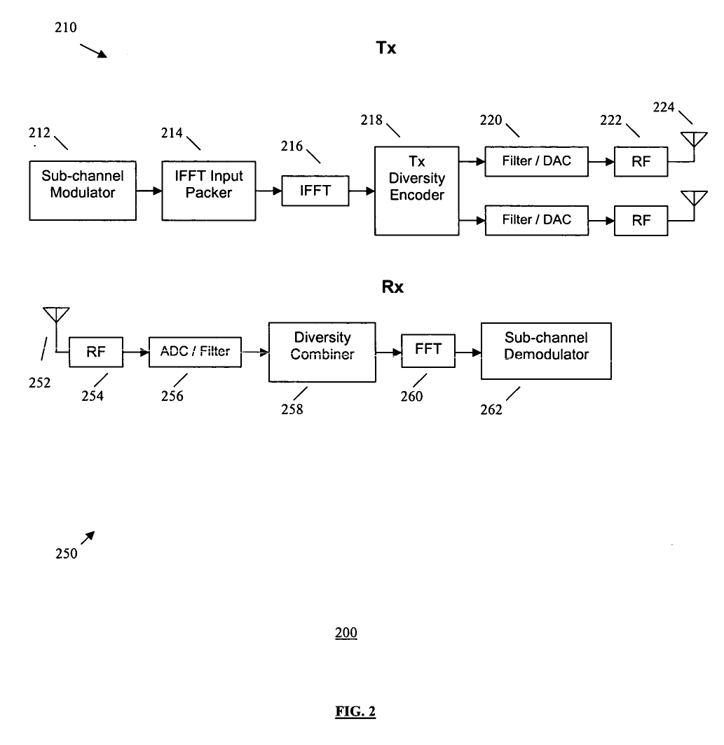

Referring to the example block diagram in FIG. 2, in one embodiment the present invention provides a OFDM system 200 including a transmitter (Tx) 210 and a receiver (Rx) 250 which is effective at least in impulsive interference channels in which their frequency responses are quite flat. In this case, frequency-domain based signal processing will not be as effective as time-domain based signal processing. The transmitter 210 comprises a sub-channel modulator 212, an IFFT input packer 214, an IFFT block 216, a diversity encoder 218, two Filter/DACs 220, two RF modulators 222 and two antennas 224.

In the sub-channel modulator 212, data streams to be transmitted are first de-multiplexed into multiple parallel sub-channels. Each sub-channel is the same as the traditional single-carrier channel that performs Forward Error Correction (FEC) encoding, interleaving, and Quadrature Amplitude Modulation (QAM). In this description, the term data includes, e.g., information, symbols, tones, control signals, video, audio, etc. The IFFT input packer 214 combines parallel modulated data symbols with pilot tones. The diversity encoder 218 implements diversity schemes by differentially encoding sub-channel time-domain data, e.g., such as described in the publication by L. Zheng and D. Tse, “Diversity and multiplexing: a fundamental tradeoff in multiple-antenna channels,” IEEE Trans. Info. Theory, vol. 49, May 2003, or in the publication by D. Gesbert, L. Haumonte, H. Bolcskei, R. Krishnamoorthy, A. Paulraj, “Technologies and performance for non-line-of-sight broadband wireless access networks,” IEEE Communications Magazine, April 2002, incorporated herein by reference. Some examples of diversity encoders include Alamouti and delay diversity encoders.

In the example system 200 according to an embodiment of the present invention, the IFFT block 216 is placed before the diversity encoder 218, wherein the IFFT process takes place before the diversity encoding process. Therefore, transmit diversity is encoded in the time-domain, i.e., after the IFFT block 216, because the transmit diversity encoder 218 after the IFFT block 216 operates on time-domain data. As such, diversity is created in the time-domain and multiple different paths after the diversity encoder 218 (multiple independent replicas in the time-domain) provide that the time-domain of the impulse signal has a different effect on the different paths. It is expected that at least one of the paths provide better performance than the others wherein, as described further below, in the receiver 250 the paths are combined to obtain diversity gain. This creates multiple independent replicas in the time-domain that can be effective in the impulsive interference channels, such as generated in power switching of various devices in the home environment.

Further, only one IFFT block 216 is used in the example transmitter 210 of FIG. 2, compared to multiple IFFT blocks 118 in the transmitter 110 of the conventional system 100 in FIG. 1. Therefore, transmitter cost is reduced in a system 200 according to the present invention. One of the example applications of the above embodiment of the present invention is in the high-speed wireless home networking system. Other example applications include net-meeting/video conferencing in enterprise networks, etc.

In the system of FIG. 2, the receiver 250 comprises an antenna 252, an RF demodulator 254, an ADC/Filter 256, a diversity combiner/decoder 258, an FFT block 260 and a sub-channel demodulator 262. The diversity combiner 258 is placed before the FFT block 260 (i.e., before the received time-domain data is converted into frequency-domain data by the FFT block 260) such that the diversity combiner 258 operates on time-domain data, whereby receive diversity is decoded in the time-domain. As such, in the receiver 250 the reverse process of the transmitter 210 is implemented.

The diversity combiner 258 implements diversity schemes for differentially decoding each sub-channel time-domain data, e.g., such as described in the two publications referenced above (i.e., Zheng et al. and Gesbert et al.). The sub-channel demodulator 262 performs the reverse process of the sub-channel modulator 212 in the transmitter 210. The parameters in the diversity encoder 218 and the diversity combiner 258 can be adjusted to improve performance according to the channel condition. Further, the dynamic range may be different between the frequency and time-domain variations in the IFFT block 216. Dynamic range is a term used to define the linearity requirement of a system. It represents the ability of the system to reproduce the signals input into it. The dynamic range of an OFDM system is typically larger by as much as 2 to 4 times that of a single carrier system. The increase in dynamic range leads to an increase in the cost and power consumption of the transmitter amplifier.

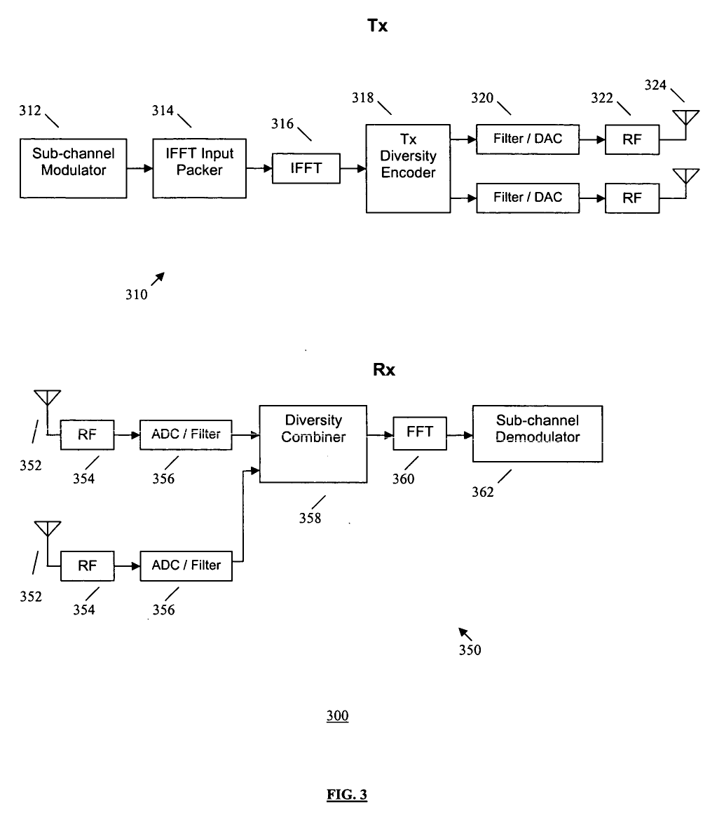

FIG. 3 shows another example system 300 according to the present invention, comprising a transmitter (Tx) 310 and a receiver (Rx) 350, which is effective at least in impulsive interference channels. Similar to the transmitter 210 in FIG. 2, the transmitter 310 in FIG. 3 comprises a sub-channel modulator 312, an IFFT input packer 314, an IFFT block 316, a diversity encoder 318, two Filter/DACs 320, two RF modulators 322 and two antennas 324. Though in the example of FIG. 3 two Filter/DACs 320, two RF modulators 322 and two antennas 324 are used, those skilled in the art will recognize that two Filter/DACs 320, multiple RF modulators 322 and multiple antennas 324 can also be used.

In the sub-channel modulator 312, data streams are first de-multiplexed into multiple parallel sub-channels. The IFFT input packer 314 combines parallel modulated data symbols with pilot tones. The diversity encoder 318 implements diversity schemes such as described above. The IFFT block 316 is placed before the diversity encoder 318, wherein the IFFT process takes place before the diversity encoding process. Therefore, transmit diversity is encoded in the time-domain, i.e., after the IFFT block 316, because the transmit diversity encoder 318 after the IFFT block 218 operates on time-domain data. This creates multiple independent replicas in the time-domain that can be effective in the impulsive interference channels, such as generated in power switching of various devices in the home environment. Further, only one IFFT block 316 is used for multiple paths in the example transmitter 310 of FIG. 3 as compared to an IFFT block 118 for each path from the diversity combiner 116.

The receiver 350 in FIG. 3 comprises two antennas 352, two RF demodulators 354, two ADC/Filters 356, a diversity combiner 358, an FFT block 360 and a sub-channel demodulator 362. Though in the example of FIG. 3 two antennas 352, two RF demodulators 354, two ADC/Filters 356 are used, those skilled in the art will recognize that multiple antennas 352, multiple RF demodulators 354 and multiple ADC/Filters 356 can be used.

The diversity combiner (decoder) 358 is placed before the FFT block 360 (i.e., before received time-domain data is converted into frequency-domain data by the FFT block 360) such that the diversity combiner 358 operates on time-domain data whereby receiver diversity is decoded in the time-domain. The sub-channel demodulator 362 performs the reverse process of the sub-channel modulator 312 in the transmitter 310. As such, in the receiver 350 the reverse process of the transmitter 310 is implemented. The diversity combiner 358 implements diversity schemes such as described above. Compared to the prior art receiver 150 in the system 100 in FIG. 1, the receiver 350 in FIG. 3 does not require additional FFT blocks 350 for additional antennas 352. As such, receiver cost is also reduced in the example system 300 of FIG. 3 according to an embodiment of the present invention.

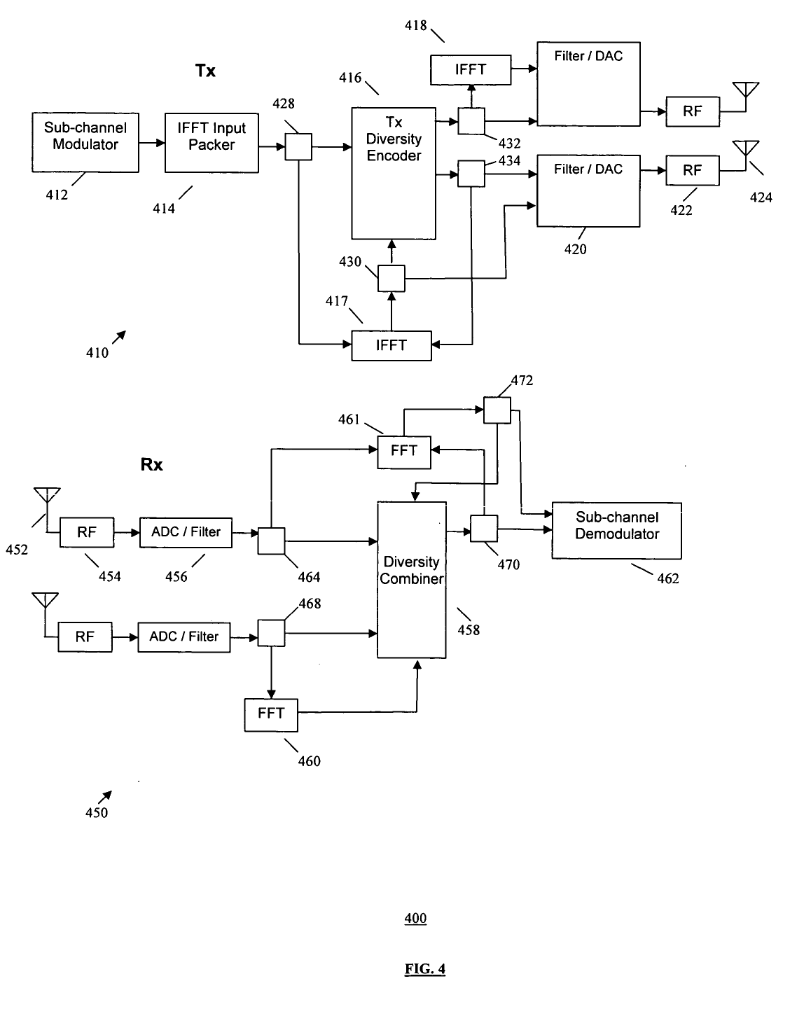

FIG. 4 shows an example system 400 according to yet another embodiment of the present invention, comprising a transmitter (Tx) 410 and a receiver (Rx) 450. As described below, in a first mode, the system 400 operates as the system 100 of FIG. 1, and in a second mode, the system 400 operates as the system 300 in FIG. 3. By selecting the first mode or the second mode, the system 400 can provides the function of the system 100 (FIG. 1) or system 300 (FIG. 3), respectively. Similar to the transmitter 310 in FIG. 3, the transmitter 410 in FIG. 4 comprises a sub-channel modulator 412, an IFFT input packer 414, a diversity encoder 418, two IFFT blocks 417, 418, two Filter/DACs 420, two RF modulators 422 and two antennas 424. The receiver 450 comprises two antennas 452, two RF demodulators 454, two ADC/Filters 456, a diversity combiner 458, two FFT blocks 460, 461 and a sub-channel demodulator 462.

Further, switches 428, 430, 432 and 434 in the transmitter 410 and switches 464, 468, 470 and 472 in the receiver 450 are provided to allow the system 400 to operate in the two modes mentioned above. In the first mode, the switches 428, 430, 432, 434, 464, 468, 470 and 472 are placed in a first position such that transmit diversity is encoded in the frequency-domain in the transmitter 410 and receive diversity is decoded in the frequency-domain in the receiver 450. Specifically in the first mode, the output of the IFFT input packer 414 is routed by the switch 428 to the first IFFT block 417 and the output of the first IFFT block 417 is routed by the switch 430 to the diversity encoder 416. Then, outputs of the diversity encoder 416 are routed to the two filter/DACs 420 by the two switches 432, 434. As such transmit diversity is encoded in the frequency-domain as in the system 100 of FIG. 1.

Further, in the system 400 of FIG. 4, in the first mode corresponding to the first mode in the transmitter 410, the switches 464, 468, 470 and 472 of the receiver 450 are placed in a first position wherein outputs of the two ADC/Filter blocks 456 are routed to the two FFT blocks 460, 461 by the switches 464, 468. Output of the FFT block 460 is directly connected to the diversity combiner 458 and output of the FFT block 461 is routed to the diversity combiner 458 by the switch 472. Further, output of the diversity combiner 458 is routed to the sub-channel demodulator 462 by the switch 470. As such, in the first mode receive diversity is decoded in the frequency-domain as in the system 100 of FIG. 1.

In the second mode, the switches 428, 430, 432, 434, 464, 468, 470 and 472 in the system 400 of FIG. 4 are placed in a second position wherein transmit diversity is encoded in the time-domain in the transmitter 410 and receive diversity is decoded in the time-domain in the receiver 450. Specifically in the second mode, the output of the IFFT input packer 414 is routed by the switch 428 to the IFFT block 417 and output of the IFFT block 417 is routed to the diversity encoder 416 by the switches 430. Then, outputs of the diversity encoder 416 are routed to Filter/DAC blocks 420 by the switches 432, 434. As such transmit diversity is encoded in the time-domain by the diversity encoder 416 as in the system 300 of FIG. 3.

In the second mode in the system 400 of FIG. 4, corresponding to the second mode in the transmitter 410, the switches 464, 468, 470, 472 in the receiver 450 are placed in a second position wherein outputs of the two ADC/Filter blocks 456 are routed to the diversity combiner 458 by the switches 464, 468, and output of the diversity combiner 458 is routed to the FFT block 461 by the switch 470. Then, output of the FFT block 461 is routed to the sub-channel demodulator 462 by the switch 472. As such, in the second mode receive diversity is decoded in the time-domain. Accordingly, in the first mode, the system 400 operates as the system 100 of FIG. 1, and in the second mode, the system 400 operates as the system 300 in FIG. 3.

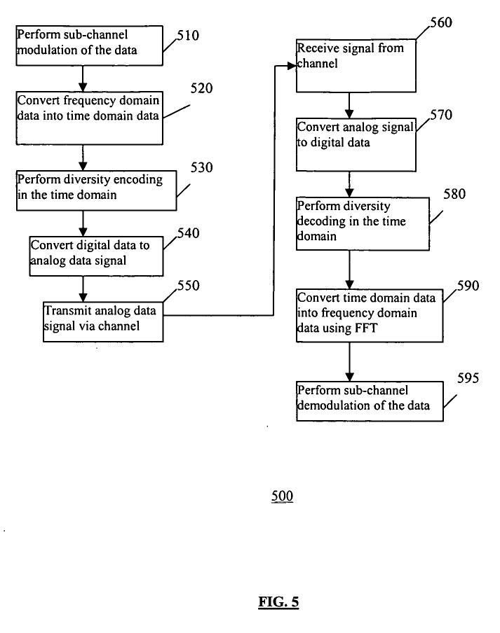

FIG. 5 shows an example flow chart 500 of the steps of time-domain transmission diversity in OFDM according to another embodiment of the present invention. The example method includes the steps of: In a transmitter, performing sub-channel modulation of frequency-domain data (step 510), converting the modulated frequency-domain data into time-domain data using IFFT processing (step 520), performing diversity encoding of the data in the time-domain (step 530), converting digital data to analog data signals (step 540), transmitting analog data signals via a channel (e.g., RF channel) to a receiver (step 550), receiving the transmitted signal in the receiver (step 560), converting the received analog signals to digital data (step 570), performing diversity decoding of the data in the time-domain (step 580), converting the time-domain data into frequency-domain data using FFT processing (step 590), and perform sub-channel demodulation of the frequency-domain data (step 595). The diversity encoding and decoding steps can be, e.g., as described in the two references (i.e., Zheng et al. and Gesbert et al.) mentioned above. The above steps can be implemented, e.g., as logic circuits, as firmware, as program instructions for execution by a processor, etc.

As such, transmit diversity is encoded in the time-domain, i.e., after the IFFT processing, whereby diversity is created in the time-domain (multiple independent replicas in the time-domain) that is effective in the impulsive interference channels, such as generated in power switching of various devices.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for transmitting OFDM data signals via multiple outputs of a channel including multiple sub-channels, comprising the steps of:
converting frequency-domain data for each sub-channel into time-domain data; and
for each sub-channel, differentially encoding the corresponding time-domain data to obtain differentially encoded time-domain data.

2. The method of claim 1, further comprising the steps of, before the step of differentially encoding the time-domain data:
modulating transmit data streams by de-multiplexing the data streams into multiple parallel frequency-domain sub-channel data for conversion into time-domain data.

3. The method of claim 1, further comprising the steps of, after differentially encoding the corresponding time-domain data, transmitting the differentially encoded time-domain data.

4. The method of claim 3, wherein the step of transmitting the data further includes the steps of:
converting the time domain data into analog data;
modulating the analog data into a signal for RF transmission;
transmitting the signal.

5. The method of claim 1, wherein the step of differentially encoding the time-domain data further includes the steps of using a diversity encoder to encode the time-domain data into diversity encoded time-domain data.

6. The method of claim 1, wherein the steps of converting frequency-domain data into time-domain data further includes the steps of performing IFFT on the frequency-domain data to generate the time-domain data.

7. A method for receiving OFDM data signals via multiple outputs of a channel including multiple sub-channels, comprising the steps of:
for each sub-channel, differentially decoding corresponding time-domain data from the data signals to obtain differentially decoded time-domain data; and
converting the time-domain data for each sub-channel into frequency-domain data.

8. The method of claim 7, further comprising the steps of, before the step of differentially decoding the time-domain data:
receiving the data signals; and
converting analog data signal into digital data signals.

9. The method of claim 7, further comprising the steps of, after converting the time-domain data for each sub-channel into frequency-domain data, demodulating the frequency-domain data into data streams by de-multiplexing the data streams into multiple parallel frequency-domain sub-channel data.

10. The method of claim 7, wherein the step of differentially decoding the time-domain data further includes the steps of using a diversity decoder to decode the time-domain data into diversity decoded time-domain data.

11. The method of claim 7, wherein the steps of converting time-domain data into frequency-domain data further includes the steps of performing FFT on the time-domain data to generate the frequency-domain data.

12. A system for transmitting OFDM data signals via multiple outputs of a channel including multiple sub-channels, comprising:
a transform processor that converts frequency-domain data for each sub-channel into time-domain data; and
a differential processor that differentially encodes each sub-channel time-domain data to obtain differentially encoded time-domain data.

13. The system of claim 12, further comprising:
a sub-channel modulator that modulates data streams by de-multiplexing the data streams into multiple parallel frequency-domain sub-channel data, wherein the sub-channel modulator provides the frequency-domain sub-channel data to the transform processor for conversion into time-domain data.

14. The system of claim 12, further comprising:
a signal transmitter that transmits the differentially encoded time-domain data.

15. The system of claim 14, wherein the signal transmitter comprises:
a digital-to-analog converter that converts the time domain data into analog data; and
a transmission modulator that modulates the analog data into a signal for RF transmission.

16. The system of claim 12, wherein the differential processor comprises a diversity encoder to encode the time-domain data into diversity encoded time-domain data.

17. The system of claim 12, wherein the transform processor comprises an IFFT processor that converts the frequency-domain data to generate the time-domain data.

18. A system for receiving OFDM data signals via multiple outputs of a channel including multiple sub-channels, comprising:
a differential processor that for each sub-channel, differentially decodes corresponding time-domain data from the data signals to obtain differentially decoded time-domain data; and
a transform processor that converts the time-domain data for each sub-channel into frequency-domain data.

19. The system, of claim 18, further comprising:
a receiver demodulator that demodulates RF received signals into analog data signals; and
an analog-to-digital converter that converts the analog data signals into digital data signals for differential decoding by the differential processor.

20. The system of claim 18, further comprising:
a sub-channel demodulator that demodulates the frequency-domain data from the transform process into data streams by de-multiplexing the data streams into multiple parallel frequency-domain sub-channel data.

21. The system of claim 18, wherein the differential processor comprises a diversity decoder to decode the time-domain data into diversity decoded time-domain data.

22. The system of claim 18, wherein the transform processor comprises an FFT processor that converts the time-domain data to the frequency-domain data.

23. A system for transmitting and receiving OFDM data signals via multiple outputs of a channel including multiple sub-channels, comprising:
a transmitter including:
a transmit transform processor that converts frequency-domain data for each sub-channel into time-domain data; and
a transmit differential processor that differentially encodes each sub-channel time-domain data to obtain differentially encoded time-domain data,
a receiver including:
a receive differential processor that for each sub-channel, differentially decodes corresponding time-domain data to obtain differentially decoded time-domain data; and
a receive transform processor that converts the time-domain data for each sub-channel into frequency-domain data.

24. The system of claim 23, wherein the transmitter further comprises:
a sub-channel modulator that modulates data streams by de-multiplexing the data streams into multiple parallel frequency-domain sub-channel data, wherein the sub-channel modulator provides the frequency-domain sub-channel data to the transform processor for conversion into time-domain data.

25. The system of claim 23, wherein the transmitter further comprises:
a signal transmitter that transmits the differentially encoded time-domain data.

26. The system of claim 25, wherein the signal transmitter comprises:
a digital-to-analog converter that converts the time domain data into analog data; and
a transmission modulator that modulates the analog data into a signal for RF transmission.

27. The system of claim 23, wherein the transmit differential processor comprises a diversity encoder to encode the time-domain data into diversity encoded time-domain data.

28. The system of claim 23, wherein the transmit transform processor comprises an IFFT processor that converts the frequency-domain data to generate the time-domain data.

29. The system of claim 23, wherein the receiver further comprises:
a receiver demodulator that demodulates RF received signals into analog data signals; and
an analog-to-digital converter that converts the analog data signals into digital data signals for differential decoding by the differential processor.

30. The system of claim 23, wherein the receiver further comprises a sub-channel demodulator that demodulates the frequency-domain data from the transform process into data streams by de-multiplexing the data streams into multiple parallel frequency-domain sub-channel data.

31. The system of claim 23, wherein the receive differential processor comprises a diversity decoder to decode the time-domain data into diversity decoded time-domain data.

32. The system of claim 23, wherein the receive transform processor comprises an FFT processor that converts the time-domain data to the frequency-domain data.

33. The system of claim 23 wherein the transmitter and the receiver utilize wireless communication therebetween.

34. The system of claim 23 wherein the transmitter further includes multiple transmit antennas.

35. The system of claim 23 wherein the receiver further includes multiple receive antennas.
